(19) United States
(12) Patent Application Publication
(10) Pub. No.: US 2024/0182349 A1
(43) Pub. Date: Jun. 6, 2024

(54) METHOD OF FABRICATING GLASS PANEL

(71) Applicant: Corning Incorporated, Coming, NY (US)

(72) Inventors: Euisoo Kim, Seongnam-si (KR); Bokyung Kong, Hwasung-city (KR); JooYoung Lee, Asan-si (KR); Byoung Hoon Moon, Seoul (KR); Kwangje Woo, Suwon-si (KR); Choon-bong Yang, Asan-si (KR)

(21) Appl. No.: 18/285,448

(22) PCT Filed: Apr. 8, 2022
(86) PCT No.: PCT/US2022/023974

§ 371 Date: Oct. 3, 2023

(30) Foreign Application Priority Data
Apr. 9, 2021 (KR) 10-2021-0046623

(51) Int. Cl. C03B 33/09; B28D 1/22; C03B 23/00; C03B 33/033

(52) U.S. Cl. CPC C03B 33/09; B28D 1/221; B28D 1/225; C03B 23/002; C03B 33/033

(57) ABSTRACT

A method of fabricating a glass panel includes forming a non-chamfered glass panel by cutting a glass sheet. The non-chamfered glass panel is formed by cutting the glass sheet along a first sideline segment, cutting the glass sheet along a corner line segment set connected to the first sideline segment, and cutting the glass sheet along a second sideline segment connected to the corner line segment set. An extension of the first sideline segment and an extension of the second sideline segment intersect each other at a first interior angle narrower than 230°. The first sideline segment and the corner line segment set are connected at an interior angle wider than the first interior angle and 180° but narrower than 230°. The corner line segment set and the second sideline segment are connected at an interior angle wider than the first interior angle and 180° but narrower than 230°.

### BACKGROUND

### Cross-Reference to Related Applications

This application claims the benefit of priority under 35 U.S.C. § 119 of Korean Patent Application Serial No. 10-2021-0046623 filed on Apr. 9, 2021, the content of which is relied upon and incorporated herein by reference in its entirety.

### Field

The present disclosure relates generally to a method of fabricating a glass panel. More particularly, the method of fabricating a glass panel forms a chamfered glass panel by heat-chamfering an edge of a non-chamfered glass panel formed by cutting a glass sheet.

### Description of Related Art

Edge finishing is performed in order to improve the edge strength of a glass panel. From among such edge finishing technologies, a heat chamfering technology is known. Heat chamfering is a technology suitable for use with thin glass plates, since no particles are caused thereby. In addition, heat chamfering may ensure superior edge strength and provide satisfactory bending performance.

However, in such heat chamfering, there have been difficulties in obtaining an intended edge shape and producing a superior yield.

### SUMMARY

Various aspects of the present disclosure provide a method of fabricating a glass panel, the method being able to obtain an intended edge shape and produce a superior yield by performing heat chamfering.

According to an aspect, a method of fabricating a glass panel may include forming a plurality of non-chamfered glass panels by cutting a glass sheet. The forming of the plurality of non-chamfered glass panels may include: cutting the glass sheet along at least one first sideline and at least one second sideline intersecting the first sideline; and cutting a corner, at which the at least one first sideline and the at least one second sideline, intersect each other at a first interior angle narrower than 140°, along at least one C-cut line segment. The first sideline and the at least one C-cut line segment or an extension of the at least one C-cut line segment may be connected at an interior angle wider than the first interior angle and 90° but narrower than 140°, and the at least one C-cut line segment or the extension of the at least one C-cut line segment and the second sideline may be connected at an interior angle wider than the first interior angle and 90° but narrower than 140°.

According to another aspect, a method of fabricating a glass panel may include forming a non-chamfered glass panel by cutting a glass sheet. The forming of the non-chamfered glass panel may include: cutting the glass sheet along a first sideline segment; cutting the glass sheet along a corner line segment set connected to the first sideline segment; and cutting the glass sheet along a second sideline segment connected to the corner line segment set. An extension of the first sideline segment and an extension of the second sideline segment may intersect each other at a first interior angle narrower than 230°, the first sideline segment and the corner line segment set may be connected at an interior angle wider than the first interior angle and 180° but narrower than 230°, and the corner line segment set and the second sideline segment may be connected at an interior angle wider than the first interior angle and 180° but narrower than 230°.

According to another aspect, a method of fabricating a glass panel may include forming a chamfered glass panel by heat-chamfering an edge of a non-chamfered glass panel formed by cutting a glass sheet. The heat chamfering may include peeling the edge of the non-chamfered glass panel by bringing a hot body into contact therewith. At least one point in an effective heating portion of a periphery of the hot body may be in contact with the non-chamfered glass panel during the heat chamfering of the non-chamfered glass panel. The center angle of the effective heating portion may range from 0° to 30°.

As set forth above, according to the present disclosure, the method of fabricating a glass panel may obtain an intended edge shape and produce a superior yield by performing heat chamfering.

The methods and apparatuses of the present disclosure have other features and advantages that will be apparent from or that are set forth in greater detail in the accompanying drawings, the disclosures of which are incorporated herein, and in the following Detailed Description, which together serve to explain certain principles of the present disclosure.

### DESCRIPTION OF THE DRAWINGS

FIG. 1 is a view schematically illustrating a heat chamfering apparatus for heat-chamfering a glass panel according to some embodiments of the present disclosure;

FIG. 2 is a schematic view illustrating a heat chamfering operation according to some embodiments of the present disclosure;

FIG. 3 is a view schematically illustrating a process of cutting a glass sheet into non-chamfered glass panels having rounded corners and heat-chamfering the non-chamfered glass panels according to a comparative example;

FIG. 4 is a view schematically illustrating a process of cutting a glass sheet into non-chamfered glass panels having C-cut corners and heat-chamfering the non-chamfered glass panels according to some embodiments of the present disclosure;

FIG. 5 is an enlarged view of the area V illustrated in FIG. 4;

FIG. 6 is a view illustrating a corner C-cutting method according to embodiments of the present disclosure;

FIG. 7 is a view illustrating a chamfered glass panel formed by corner round-cutting and edge chamfering

FIG. 8 is a view illustrating a non-chamfered glass panel on which the corner C-cutting was performed;

FIG. 9 is a view illustrating a chamfered glass panel formed by edge-chamfering the non-chamfered glass panel illustrated in FIG. 8;

FIG. 10 is a schematic view illustrating corner C-cutting according to embodiments of the present disclosure;

FIG. 11 is a schematic view illustrating cutting lines for a corner having an acute interior angle according to some embodiments of the present disclosure;

FIG. 12 is a view illustrating a concave mark that may be formed in a chamfered glass panel fabricated by a method according to a comparative example;

FIG. 13 is a schematic view illustrating cutting lines for a corner having an interior right angle according to embodiments of the present disclosure; and

FIG. 14 is a schematic view illustrating cutting lines for a corner having an obtuse interior angle according to embodiments of the present disclosure.

### DETAILED DESCRIPTION

Hereinafter, embodiments of the present disclosure will be described in detail with reference to the accompanying drawings.

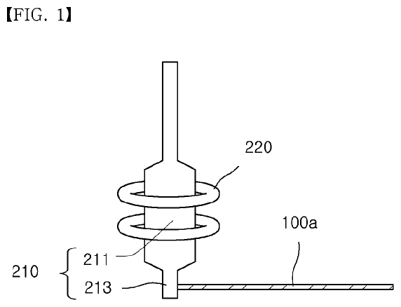

FIG. 1 is a view schematically illustrating a heat chamfering apparatus for heat-chamfering a glass panel according to some embodiments of the present disclosure.

An edge of a non-chamfered glass panel 100a may be heat-chamfered by thermal shock applied thereto. In some embodiments, thermal shock may be applied to the edge of the glass panel 100a by bringing a hot body 210 into contact therewith. In some embodiments among these embodiments, the edge of the glass panel 100a may be chamfered by moving the hot body 210 relatively with respect to the glass panel 100a along the edge of the glass panel 100a while keeping the hot body 210 in contact with the edge of the glass panel 100a. For the relative movement, the glass panel 100a may be moved, the hot body 210 may be moved, or both the glass panel 100a and the hot body 210 may be moved.

The glass panel 100a may typically be a thin substrate, with the thickness (e.g., the measurement in the Z-axis direction) thereof being smaller than the transverse length (e.g., the measurement in the X-axis direction) and the longitudinal length (e.g., the measurement in the Y-axis direction) of the main plane thereof, but is not limited thereto. The glass panel 100a may have a variety of shapes and may be, for example, in the shape of a thick block.

The glass panel 100a according to the present disclosure may include panels formed from any glass material (e.g., borosilicate glass).

When the main plane of the glass panel 100a has a rectangular shape and is referred to as an XY plane, the hot body 210 may chamfer the glass panel 100a by relatively moving in the X-axis direction and the Y-axis direction while sequentially being in contact with four edges of the glass panel 100a. The speed of the relative movement may vary depending on the composition of the glass, the temperature conditions, the shape of the glass panel 100a to be chamfered, or the like. In response to this chamfering, a strip is peeled off from the edges of the glass panel 100a. In some embodiments, the hot body 210 may perform the chamfering while continuously coming into contact with the four edges of the glass panel 100a. For example, when the four edges of the glass panel 100a are referred to as a first edge, a second edge, a third edge, and a fourth edge in the clockwise direction, the hot body 210 may chamfer the entirety of the four edges of the glass panel 100a by relatively moving in the X-axis direction until reaching the corner between the first edge and the second edge while being in contact with the first edge, relatively moving in the Y-axis direction until reaching the corner between the second edge and the third edge while being in contact with the second edge, relatively moving in the X-axis direction (i.e., a direction opposite to the direction in which the hot body 210 moves while in contact with the first edge) until reaching the corner between the third edge and the fourth edge while being in contact with the third edge, and then, relatively moving in the Y-axis direction (i.e., a direction opposite to the direction in which the hot body 210 moves while in contact with the second edge) until reaching the corner between the fourth edge and the first edge while being in contact with the fourth edge.

This chamfering may peel the thin strip off from the glass panel 100a without forming dust, thereby preventing defects in the edges of the glass panel 100a and increasing the strength of the chamfered glass panel.

In some embodiments, the chamfering may be performed in a situation in which the glass panel 100a is located on the top surface of a bed (not shown). The size of the bed may be substantially the same as the size of the glass panel 100a or may be greater or smaller than the size of the glass panel 100a depending on the environment in which the chamfering is performed. Suction holes able to hold the glass panel 100a by suction may be formed in the surface of the bed. The suction holes may be connected to a vacuum pump that produces a low air pressure. When the surface of the glass panel 100a is held by vacuum suction, no fixing tools are required to be provided on sides of the glass panel 100a to hold the glass panel 100a. Thus, the contact of the hot body 210 with the glass panel 100a may be smoothly performed along the four edges of the glass panel 100a.

In some embodiments, the hot body 210 may include a heating rod. In some embodiments, one end of the heating rod to be in contact with the glass panel 100a may have the shape of a cylinder. In some embodiments, the thickness of the heating rod may be varied in the length direction thereof, as illustrated in FIG. 1. However, the present disclosure is not limited thereto and the heating rod may have a variety of shapes. For example, the heating rod may be a rod having a single thickness. In some embodiments, the heating rod may be a metal rod. For example, the heating rod may be implemented using a metal rod formed from MoSi₂. However, the heating rod is not limited thereto. At a specific point in time, the hot body 210 may be in point contact, line contact or surface contact with the glass panel 100a. In some embodiments, the line in the line contact and the surface in the surface contact may be parallel to a side surface (i.e., a thickness surface) of the glass panel 100a. However, the present disclosure is not limited thereto and the contact line or surface may be oriented at a predetermined angle to the side surface.

In some embodiments, the hot body 210 may be heated by high-frequency induction heating. The hot body 210 may be heated using an induction coil 220 connected to a high-frequency induction heater. The induction coil 220 may be disposed surrounding the hot body 210 to heat the hot body 210 by induction heating. The high-frequency induction heater may be commercially available. The operating conditions of the high-frequency induction heater may vary depending on the state of the glass panel 100a or the surrounding environment. For example, the operating conditions may be adjusted in the range from 100 V to 200 V, from 60 A to 70 A, or from 200 Hz to 300 Hz.

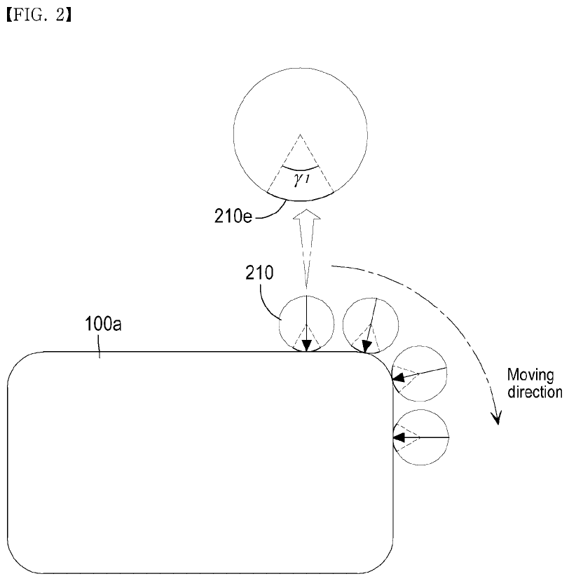

FIG. 2 is a schematic view illustrating a heat chamfering operation according to some embodiments of the present disclosure.

The heat chamfering may peel an edge of the non-chamfered glass panel 100a by bringing the hot body into contact with the edge of the non-chamfered glass panel 100a. In some embodiments, while the edge of the non-chamfered glass panel 100a is being heat-chamfered, at least one point in an effective heating portion 210e of the periphery of the hot body may be in contact with the non-chamfered glass panel 100a. In some embodiments, the effective heating portion 210e may have a center angle γ1 ranging from 0° to 30°. For example, when a cylindrical hot body is used, the center angle of the entire outer circumference of the hot body is 360°, and a maximum 1/12 (=30/360) of the entire outer circumference is an effective heating portion 210e. At least one point in the effective heating portion 210e may be in contact with the non-chamfered glass panel 100a. When the glass panel is not continuously maintained in contact with the effective heating portion 210e, the temperature of the glass panel may temporarily drop, and thereby, the heat chamfering may be stopped or the edge quality of the glass panel may be significantly degraded. Molten glass sticking to the effective heating portion 210e of the periphery of the hot body helps the glass be melted more easily in the subsequent process, thereby facilitating the heat chamfering.

When Glass Panel is Required to have Superior Corner Strength Property or Rounded Corner Shape

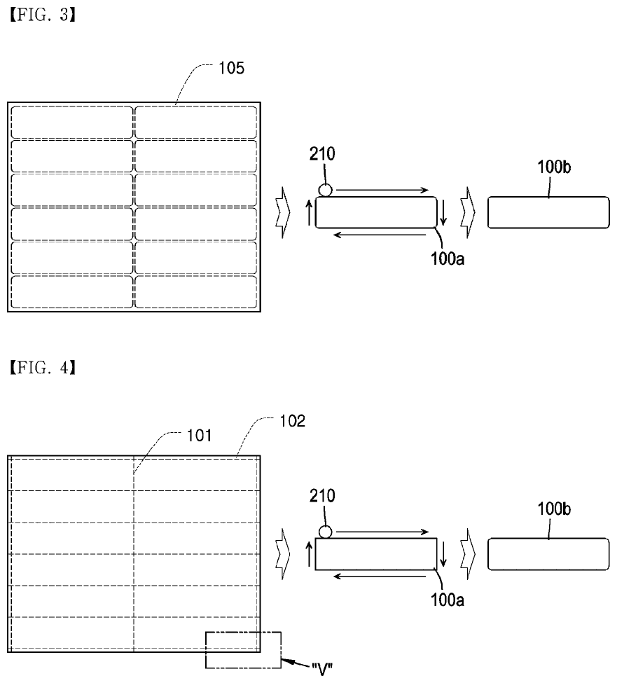

FIG. 3 is a view schematically illustrating a chamfering process for non-chamfered glass panels 100a having rounded corners according to a comparative example.

If a finally-formed glass panel has angled corners, the corner portions vulnerable to damage may inevitably reduce the reliability of the glass panel. Thus, it is necessary to chamfer the finally-formed glass panel to have rounded corners. However, when round chamfering is performed to a rectangular non-chamfered glass panel 100a having angled corners, the chamfering cannot be continued at each of the corners. That is, when the rectangular non-chamfered glass panel 100a has angled corners, it is not possible to chamfer the entirety or at least a substantial portion of the edges of the rectangular non-chamfered glass panel 100a in a single step. When the chamfering is stopped and then resumed during the process, a portion of the glass panel at which the chamfering is stopped is melted slightly and then is solidified, thereby forming a concave-convex structure. The concave-convex structure may act as a defect in the edge of the glass panel, thereby significantly reducing the edge strength of the glass panel.

Thus, in order to chamfer the entirety of the edges of the non-chamfered glass panel 100a in a single step, it may be necessary to cut the non-chamfered glass panel 100a to have rounded corners before the chamfering, as illustrated in FIG. 3. However, the operation of cutting the glass sheet to have rounded corners is more time consuming than an operation of cutting the glass sheet along straight lines. In addition, it is very difficult to accurately align cutting lines 105 and, even if the cutting lines 105 can be accurately aligned, it is inefficient in terms of cost and processing. Thus, in order to obtain rounded corners, each of the non-chamfered glass panels 100a is required to have its own cutting lines 105, and a distance of at least about 4 mm is required between the adjacent non-chamfered glass panels 100a. This leads to the waste of material, thereby causing the yield of glass panel fabrication to be reduced.

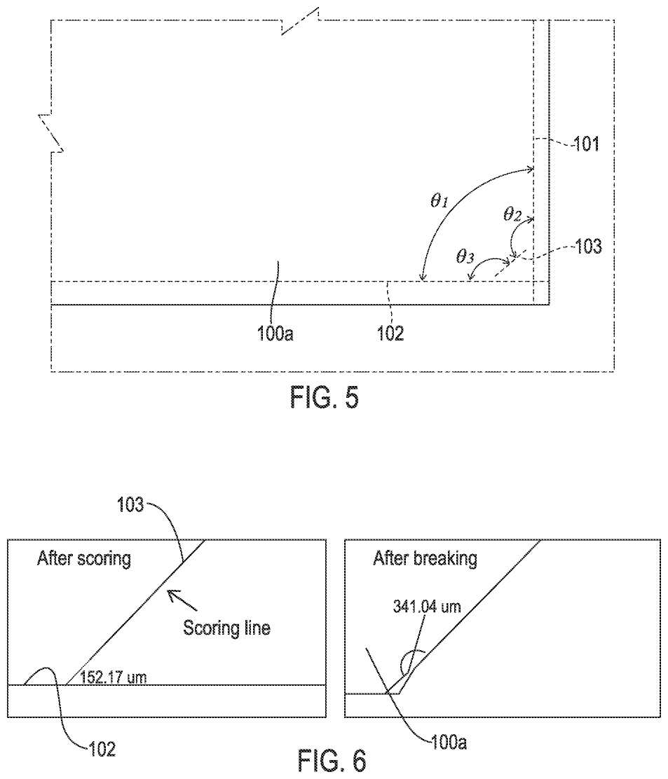

FIG. 4 is a view schematically illustrating a process of chamfering non-chamfered glass panels 100a having C-cut corners according to embodiments of the present disclosure, and FIG. 5 is an enlarged view of the corner C-cutting operation illustrated in FIG. 4.

A plurality of chamfered glass panels 100a may be formed by cutting a glass sheet into a plurality of non-chamfered glass panel 100a and then heat-chamfering edges of the plurality of non-chamfered glass panels 100a.

The operation of cutting the glass sheet may include: cutting the glass sheet along at least one first sideline 101 and at least one second sideline 102 intersecting the first sideline 101; and then, cutting a corner, at which the at least one first sideline 101 and the at least one second sideline 102 intersect each other at a first interior angle Θ1 narrower than 140°, along at least one C-cut line segment 103 (hereinafter, referred to as the “corner C-cutting”). That is, when the chamfering is performed after the corner C-cutting in place of the operation of cutting the glass sheet to have rounded corners (hereinafter, referred to as the “corner round-cutting”), the finally-formed chamfered glass panel may also have rounded corners. The chamfering of the entirety of edges of the non-chamfered glass panel 100a may be completed by a single continuous chamfering process, thereby forming the round-corner glass panel having superior corner strength characteristic.

In some embodiments, each of an interior angle Θ2 defined by the intersection of the first sideline 101 and the at least one C-cut line segment 103 or an extension of the C-cut line segment 103 and an interior angle Θ3 defined by the intersection of the second sideline 102 and the at least one C-cut line segment 103 or the extension of the C-cut line segment 103 may be wider than the first interior angle and 90° but narrower than 140°.

In some embodiments, the at least one first sideline 101 and the at least one second sideline 102 may intersect each other at right angles. That is, the first interior angle Θ1 may be 90°.

The first sideline 101 may be a line defined by a single functional formula, for example, a straight line, an arc, or an elliptical arc. The at least one C-cut line segment 103 may be a line defined by a single functional formula, for example, a straight line segment, an arc segment, or an elliptical arc segment. The second sideline 102 may be a line defined by a single functional formula, for example, a straight line, an arc, or an elliptical arc.

FIG. 6 is a view illustrating a corner C-cutting method according to embodiments of the present disclosure.

In some embodiments, the C-cut line segment 103 may not intersect any of the first sideline 101 and the second sideline 102. The cutting along the C-cut line segment 103 may include scoring the C-cut line segment 103 and dividing the glass sheet along the C-cut line segment 103 and the extension of the C-cut line segment 103. For example, the scoring may be performed on a 100 μm-thick glass sheet, such as Willow glass available from Corning Incorporated, to a depth of 3 μm or less. In this manner, it is possible to prevent the C-cut line segment 103 drawn on any glass panel from invading an adjacent non-chamfered glass panel, thereby preventing any defect that would otherwise be caused in the adjacent glass panel.

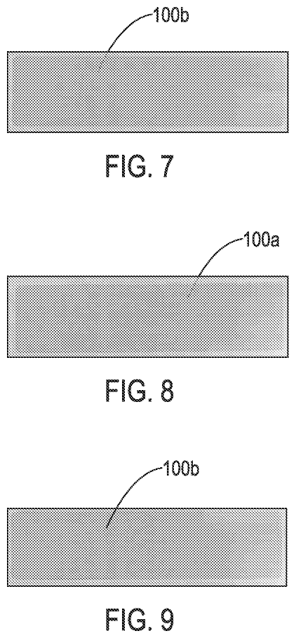

FIG. 7 is a view illustrating a glass panel formed by corner round-cutting and edge chamfering.

A chamfered glass panel 100b illustrated in FIG. 7 was formed by performing 5 mm-R corner round-cutting and then edge chamfering.

Table 1 below illustrates the radii of curvature of corners of chamfered-glass panels 100b formed by performing the corner round-cutting and then the edge chamfering. Even in the case that the radius of curvature of the round-cutting was sufficiently small, none of the radii of curvature of corners of the final chamfered-glass panels 100b formed after the chamfering was smaller than 3.2 mm. When the radius of curvature of the round-cutting was smaller, continuous chamfering was impossible, and edge quality was degraded as a result.

TABLE 1

Design

| Sample# | R1.0 | R1.5 |
|---|---|---|
| G1 | | 4.0 |
| G2 | | 3.9 |
| G3 | | 3.9 |
| G4 | | 3.7 |
| G5 | 3.2 | |
| G6 | 3.6 | |
| Average | 3.4 | 3.9 |

FIG. 8 is a view illustrating a non-chamfered glass panel 100a on which the corner C-cutting was performed, and FIG. 9 is a view illustrating a chamfered glass panel 100b formed by edge-chamfering the non-chamfered glass panel 100a illustrated in FIG. 8.

The non-chamfered glass panel 100a illustrated in FIG. 8 was formed by performing 3×3 mm C-cutting, and the chamfered glass panel 100b illustrated in FIG. 9 was formed by edge-chamfering the non-chamfered glass panel 100a. As illustrated in FIG. 9, it may be found that the finally-formed chamfered glass panel 100b had rounded corners although a round-cutting was not performed.

Table 2 below illustrates the radii of curvature of corners of chamfered-glass panels 100b formed by performing the edge chamfering at a variety of tip speeds after 1×1 mm C-cutting at the corner. When compared to the results of Table 1, the chamfered glass panels 100b respectively having a much smaller corner radii of curvature were formed. Considering that the sharper corners were formed, it was found that better results may be obtained by performing the chamfering after the C-cutting than by performing the chamfering after the round-cutting. In addition, as can be seen from the results of Table 2, the tip speeds had no significant effects on the shape of the corner.

TABLE 2

| Speed | C-cut 1^{st} | C-cut 2^{nd} |
|---|---|---|
| (mm/s) | (90°) | (90°) |
| 3 | 2.78 | 2.45 |
| 5 | 2.94 | 2.19 |
| 7 | 2.26 | 2.74 |
| 8 | 2.62 | 2.50 |
| 9 | 2.24 | 2.55 |
| 11 | 2.26 | 2.33 |
| Average | 2.48 | 2.50 |

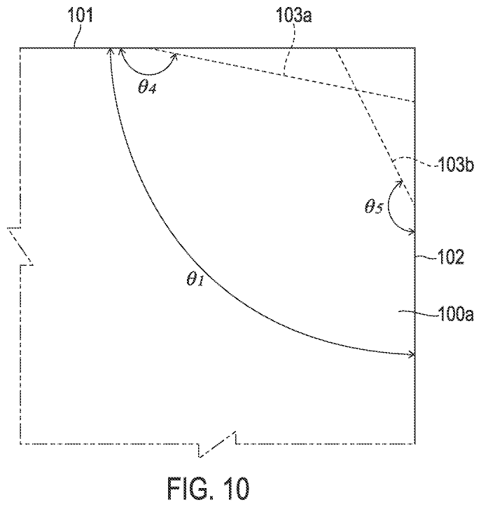

FIG. 10 is a schematic view illustrating corner C-cutting according to embodiments of the present disclosure.

While FIG. 5 illustrates an embodiment in which the corner cutting is performed along the single C-cut line segment 103, FIG. 10 illustrates an embodiment in which the corner cutting is performed along two C-cut line segments 103a and 103b.

The first sideline 101 and the second sideline 102 may intersect each other at a first interior angle Θ1 narrower than 140°. The first sideline 101 and the C-cut line segment 103a may be connected to each other at an interior angle Θ4 wider than first interior angle Θ1 and 90° but narrower than 140°, and the C-cut line segment 103b and the second sideline 102 may be connected to each other at an interior angle Θ5 wider than first interior angle Θ1 and 90° but narrower than 140°.

When Glass Panel is Required to have Sharp Corner Shape

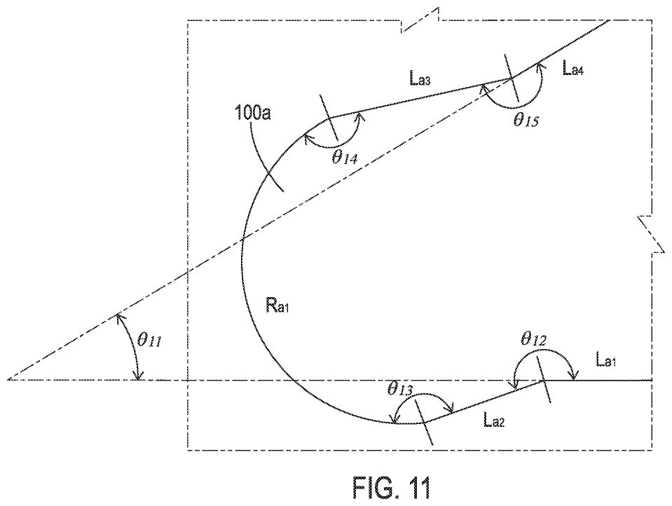

FIG. 11 is a schematic view illustrating cutting lines for a corner having an acute interior angle according to embodiments of the present disclosure.

An edge of the non-chamfered glass panel 100a is peeled by heat chamfering. However, when the heat chamfering is performed by simply following the edge of the non-chamfered glass panel 100a having an angled corner, different amounts of glass are peeled off from a straight line edge and from a corner line edge. An amount of glass corresponding to a width in a range, for example, from 200 μm to 250 μm may be removed from the straight line edge by the chamfering, whereas an amount of glass corresponding to a width in a range, for example, from 400 μm to 500 μm may be removed from the corner edge by the chamfering. Accordingly, the shape of the finally-formed chamfered glass panel may be different from an intended shape.

The non-chamfered glass panel 100a may be formed by cutting a glass sheet, and the chamfered glass panel may be formed by heat-chamfering the edge of the non-chamfered glass panel 100a. The forming of the non-chamfered glass panel 100a may include: cutting the glass sheet along a first sideline segment La1 defining a first side of the non-chamfered glass panel 100a; cutting the glass sheet along a corner line segment set connected to the first sideline segment La1 and defining the corner of the non-chamfered glass panel 100a; and cutting the glass sheet along a second sideline segment La4 connected to the corner line segment set and defining a second side of the non-chamfered glass panel 100a.

A corner line end segment may include a first corner line end segment La2 connected to the first sideline segment La1 and a second corner line end segment La3 connected to the second sideline segment La4. In addition, the corner line segment may include at least one intermediate corner line segment Ra1 between the first corner line end segment La2 and the second corner line end segment La3.

In some embodiments, an extension of the first sideline segment La1 and an extension of the second sideline segment La4 may intersect each other at a first interior angle Θ11 narrower than 230°. In some of these embodiments, the glass sheet may be cut such that the sideline segments La1 and La4 and the corner line end segments La2 and La3 are connected at interior angles Θ12 and Θ15 respectively narrower than 230°.

In some embodiments, the glass sheet may be cut such that the first corner line end segment La2, the at least one intermediate corner line segment Ra1, and the second corner line end segment La3 are connected at interior angles Θ13 and Θ14 respectively wider than 100° but narrower than 230°. That is, the cutting may be performed so that each of i) the interior angle Θ13 between the first corner line end segment La2 and the adjacent intermediate corner line segment Ra1 and ii) the interior angle Θ14 between the second corner line end segment La3 and the adjacent intermediate corner line segment Ra1 is wider than 100° but narrower than 230°.

The first sideline segment La1, the corner line segment set, and the second sideline segment La4 may be obtained by a continuous cutting process without interruption.

In some embodiments, each segment of the first sideline segment La1, the corner line segment set, and the second sideline segment La4 may be a line segment defined by a single functional formula, for example, a straight line segment, an arc segment, or an elliptical arc segment. The curvature of each of the corner line end segments La2 and La3 may be 0 mm⁻¹. That is, the corner line end segments La2 and La3 may be straight lines, respectively. While the corner line end segments La2 and La3 formed as straight lines may be omitted, the corners may be obtuse in this case. The length of each of the first sideline segment La1 and the second sideline segment La4 may be 15 mm or longer.

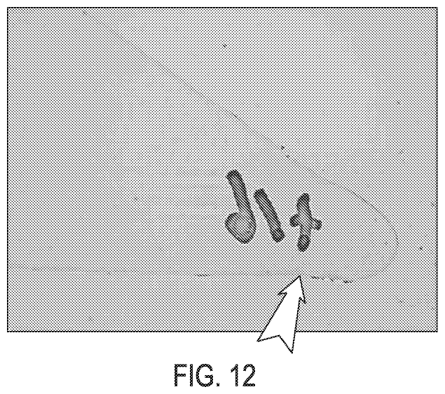

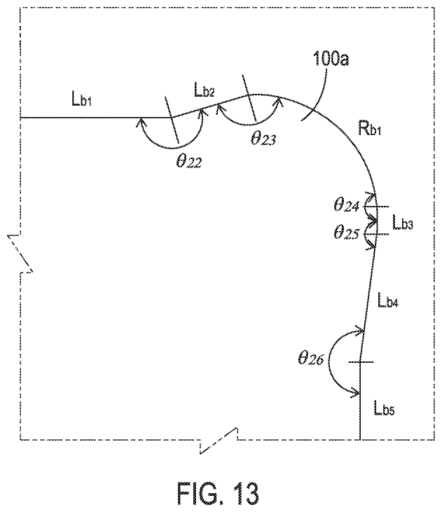

The second corner line end segment La3 allows the hot body 210 to smoothly enter the second sideline segment La4 so that the final chamfered glass panel having an intended shape may be formed. When the corner line end segment La3 formed as a straight line is omitted, a concave mark as indicated with an arrow in FIG. 12 may be formed on the chamfered glass panel.

In some embodiments, the radius of curvature of the intermediate corner line segment Ra1 may be 0 mm⁻¹ or more.

FIG. 11 illustrates an embodiment in which the second corner line end segment La3 is connected to the second sideline segment La4 and to the intermediate corner line segment Ra1 at interior angles 200° and 160° respectively narrower than 230°. If the intermediate corner line segment Ra1 formed as a curved line is directly connected to the sideline segment La4 at an interior angle wider than 230°, a wavy edge may be formed on the final glass panel formed after the chamfering.

FIG. 13 is a schematic view illustrating cutting lines for a corner having an interior right angle according to embodiments of the present disclosure.

In some embodiments, the chamfering may also be performed on the corner having an interior right angle, along sequentially a first sideline segment Lb1, a corner line segment set Lb2, Rb1, Lb3, and Lb4, and a second sideline segment Lb5. A corner line intermediate segment Lb3 formed as a straight line may be located between a corner line intermediate segment Rb1 formed as a curved line and a second corner line end segment Lb4 formed as a straight line. Since the corner line intermediate segment Lb3 formed as a straight line is provided, the corner of the glass panel finally formed after the chamfering may have an intended shape.

As illustrated in FIG. 13, the first interior angle between the extension of the first sideline segment Lb1 and the extension of the second sideline segment Lb5 is a right angle and thus is narrower than 230°. The glass sheet may be cut along the sideline segments Lb1 and Lb5 and the corner line end segments Lb2 and Lb4 connected at interior angles Θ22 and Θ26 respectively wider than the first interior angle and 180° but narrower than 230°.

In some embodiments, the glass sheet may be cut along a first corner line end segment Lb2, at least one corner line intermediate segment Rb1 and Lb3, and a second corner line end segment La4 connected at interior angles Θ23, Θ24, and Θ25 respectively wider than 100° but narrower than 230°. That is, the glass sheet may be cut along the first corner line end segment Lb2, the at least one corner line intermediate segment Rb1 and Lb3, and the second corner line end segment La4 connected such that each of i) the interior angle Θ23 between the first corner line end segment Lb2 and the adjacent corner line intermediate segment Rb1, ii) the interior angle Θ24 between the adjacent corner line intermediate segments Rb1 and Lb3, and iii) the interior angle Θ25 between the second corner line end segment Lb4 and the adjacent corner line intermediate segment Lb3 is wider than 100° but narrower than 230°.

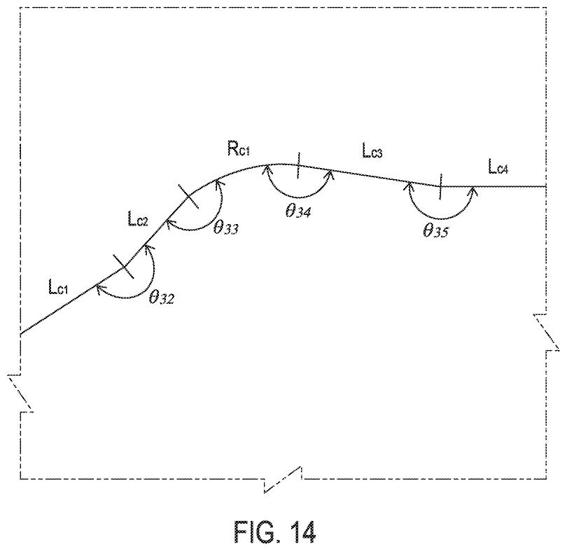

FIG. 14 is a schematic view illustrating cutting lines for a corner having an obtuse interior angle according to embodiments of the present disclosure.

In some embodiments, the chamfering may be performed on the corner having an obtuse interior angle, along sequentially a first sideline segment Lc1, a corner line segment set Lc2, Rc1, and Lc3, and a second sideline segment Lc4.

In some embodiments, an extension of the first sideline segment Lc1 and an extension of the second sideline segment Lc4 may intersect each other at a first interior angle narrower than 230°. In some of these embodiments, the glass sheet may be cut along the sideline segments Lc1 and Lc4 and the corner line end segments Lc2 and Lc3 connected at interior angles Θ32a and Θ35 respectively wider than the first interior angle and 180° but narrower than 230°.

In some embodiments, the glass sheet may be cut along a first corner line end segment Lc2, at least one corner line intermediate segment Rc1, and a second corner line end segment Lc3 connected at interior angles Θ33 and Θ34 respectively wider than 100° but narrower than 230°. That is, the glass sheet may be cut along the first corner line end segment Lc2, the at least one corner line intermediate segment Rc1, and the second corner line end segment Lc3 that are connected such that each of i) the interior angle Θ33 between the first corner line end segment Lc2 and the adjacent corner line intermediate segment Rc1 and ii) the interior angle Θ34 between the second corner line end segment Lc3 and the adjacent corner line intermediate segment Rc1 is wider than 100° but narrower than 230°.

As illustrated in FIGS. 11, 13, and 13, according to embodiments of the present disclosure, a non-chamfered glass panel may be formed by the corner cutting, and a chamfered glass panel may be formed by heat-chamfering the formed non-chamfered glass panel. The chamfered glass formed in this manner may have an intended sharp corner shape.

Aspect (1) of this disclosure pertains to a method of fabricating a glass panel, the method comprising: cutting a glass sheet along at least one first sideline and at least one second sideline intersecting the first sideline; and cutting a corner, at which the at least one first sideline and the at least one second sideline intersect each other at a first interior angle narrower than 140°, along at least one C-cut line segment, wherein the first sideline and the at least one C-cut line segment or an extension of the at least one C-cut line segment are connected at an interior angle wider than the first interior angle and 90° but narrower than 140°, and the at least one C-cut line segment or the extension of the at least one C-cut line segment and the second sideline are connected at an interior angle wider than the first interior angle and 90° but narrower than 140°. In one or more aspects, this method may include cutting the glass sheet to form a plurality of non-chamfered glass panels, each of which are formed by cutting a glass sheet along at least one first sideline and at least one second sideline intersecting the first sideline; and cutting a corner, at which the at least one first sideline and the at least one second sideline intersect each other at a first interior angle narrower than 140°, along at least one C-cut line segment, wherein the first sideline and the at least one C-cut line segment or an extension of the at least one C-cut line segment are connected at an interior angle wider than the first interior angle and 90° but narrower than 140°, and the at least one C-cut line segment or the extension of the at least one C-cut line segment and the second sideline are connected at an interior angle wider than the first interior angle and 90° but narrower than 140°.

Aspect (2) of this disclosure pertains to the method of Aspect (1), wherein the first interior angle is 90°.

Aspect (3) of this disclosure pertains to the method of Aspect (1) or Aspect (2), wherein the at least one C-cut line segment does not intersect any of the first sideline and the second sideline, and the cutting of the corner of the glass sheet along the at least one C-cut line segment comprises: scoring the at least one C-cut line segment; and dividing the glass sheet along the at least one C-cut line segment and the extension of the at least one C-cut line segment.

Aspect (3) of this disclosure pertains to the method of any one of Aspects (1) through (3), wherein the first sideline is a line defined by a single functional formula, the at least one C-cut line segment line is a segment defined by a single functional formula, and the second sideline is a line defined by a single functional formula.

Aspect (5) of this disclosure pertains to the method of any one of Aspects (1) through (4), further comprising forming a chamfered glass panel by heat-chamfering an edge of the glass panel or plurality of glass panels.

Aspect (6) of this disclosure pertains to the method of Aspect (5), wherein the heat-chamfering comprises heat-chamfering the at least one first sideline, the at least one C-cut line segment, and the at least one second sideline in a single continuous process.

Aspect (7) of this disclosure pertains to the method of Aspect (5) or Aspect (6), wherein the heat-chamfering comprises peeling the edge of the glass panel or edge of each of the plurality of glass panels by bringing a hot body into contact with the edge of the glass panel or edge of each of the plurality of glass panels, at least one point in an effective heating portion of a periphery of the hot body is in contact with the non-chamfered glass panel or glass panels during the heat-chamfering of the edge of the non-chamfered glass panel or glass panels, and the center angle of the effective heating portion ranges from 0° to 30°.

Aspect (8) of this disclosure pertains to a method of fabricating a glass panel, the method comprising: cutting the glass sheet along a first sideline segment; cutting the glass sheet along a corner line segment set connected to the first sideline segment; and cutting the glass sheet along a second sideline segment connected to the corner line segment set, and wherein an extension of the first sideline segment and an extension of the second sideline segment intersect each other at a first interior angle narrower than 230°, the first sideline segment and the corner line segment set are connected at an interior angle wider than the first interior angle and 180° but narrower than 230°, and the corner line segment set and the second sideline segment are connected at an interior angle wider than the first interior angle and 180° but narrower than 230°.

Aspect (9) of this disclosure pertains to the method of Aspect (8), wherein the corner line segment set comprises: a first corner line end segment connected to the first sideline segment; a second corner line end segment connected to the second sideline segment; and at least one intermediate corner line segment connecting the first corner line end segment and the second corner line end segment, wherein the first corner line end segment, the at least one intermediate corner line segment, and the second corner line end segment are connected at interior angles respectively wider than 100° but narrower than 230°.

Aspect (10) of this disclosure pertains to the method of Aspect (9), wherein the at least one intermediate corner line segment comprises a curvature that is 0 mm⁻¹ or wider.

Aspect (11) of this disclosure pertains to the method of Aspect (9), wherein each of the first corner line end segment and the second corner line end segment comprises a curvature that is 0 mm⁻¹ or wider.

Aspect (12) of this disclosure pertains to the method of any one of Aspects (8) through (11), wherein the glass sheet is cut along the first sideline segment, the corner line segment set, and the second sideline segment by continuous processing.

Aspect (13) of this disclosure pertains to the method of any one of Aspects (8) through (12), wherein each segment of the first sideline segment, the corner line segment set, and the second sideline segment is a line segment defined by a single functional formula.

Aspect (14) of this disclosure pertains to the method of any one of Aspects (8) through (13), wherein the length of each of the first sideline segment and the second sideline segment is 15 mm or longer.

Aspect (15) of this disclosure pertains to the method of any one of Aspects (8) through (14), further comprising forming a chamfered glass panel by heat-chamfering an edge of the non-chamfered glass panel.

Aspect (16) of this disclosure pertains to the method of Aspect (15), wherein the heat-chamfering comprises peeling the edge of the non-chamfered glass panel by bringing a hot body into contact with the edge of the non-chamfered glass panel, at least one point in an effective heating portion of a periphery of the hot body is in contact with the non-chamfered glass panel during the heat-chamfering of the edge of the non-chamfered glass panel, and the center angle of the effective heating portion ranges from 0° to 30°.

Aspect (17) of this disclosure pertains to a method of fabricating a glass panel, the method comprising: heat-chamfering an edge of a non-chamfered glass panel, wherein the heat-chamfering comprises peeling the edge of the non-chamfered glass panel by bringing a hot body into contact with the edge of the non-chamfered glass panel, at least one point in an effective heating portion of a periphery of the hot body is in contact with the non-chamfered glass panel during the heat-chamfering of the non-chamfered glass panel, and the center angle of the effective heating portion ranges from 0° to 30°. In one or more aspects, this method may include forming a chamfered glass panel by heat-chamfering an edge of a non-chamfered glass panel formed by cutting a glass sheet, wherein the heat-chamfering comprises peeling the edge of the non-chamfered glass panel by bringing a hot body into contact with the edge of the non-chamfered glass panel, at least one point in an effective heating portion of a periphery of the hot body is in contact with the non-chamfered glass panel during the heat-chamfering of the non-chamfered glass panel, and the center angle of the effective heating portion ranges from 0° to 30°.

The present disclosure is not limited to the foregoing embodiments described above and illustrated in the drawings. Rather, a person having ordinary skill in the art will appreciate that various modifications and changes are possible without departing from the scope of the appended claims. The features described in each of the following claims may be combined unless explicitly described to the contrary. For example, when two dependent claims referring to an independent claim are recited in such a manner that any one of the two dependent claims does not directly refer to the other of the two dependent claims, the features of the two dependent claims may be concurrently realized in a specific embodiment and such embodiments shall fall within the scope of right of the present disclosure.

1. A method of fabricating a glass panel, the method comprising:
cutting a glass sheet along at least one first sideline and at least one second sideline intersecting the first sideline; and
cutting a corner, at which the at least one first sideline and the at least one second sideline intersect each other at a first interior angle narrower than 140°, along at least one C-cut line segment,
wherein the first sideline and the at least one C-cut line segment or an extension of the at least one C-cut line segment are connected at an interior angle wider than the first interior angle and 90° but narrower than 140°, and the at least one C-cut line segment or the extension of the at least one C-cut line segment and the second sideline are connected at an interior angle wider than the first interior angle and 90° but narrower than 140°.

2. The method of claim 1, wherein the first interior angle is 90°.

3. The method of claim 1, wherein the at least one C-cut line segment does not intersect any of the first sideline and the second sideline, and
the cutting of the corner of the glass sheet along the at least one C-cut line segment comprises:
scoring the at least one C-cut line segment; and
dividing the glass sheet along the at least one C-cut line segment and the extension of the at least one C-cut line segment.

4. The method of claim 1, wherein the first sideline is a line defined by a single functional formula,
the at least one C-cut line segment line is a segment defined by a single functional formula, and
the second sideline is a line defined by a single functional formula.

5. The method of claim 1, further comprising forming a chamfered glass panel by heat-chamfering an edge of the glass panel.

6. The method of claim 5, wherein the heat-chamfering comprises heat-chamfering the at least one first sideline, the at least one C-cut line segment, and the at least one second sideline in a single continuous process.

7. The method of claim 5, wherein the heat-chamfering comprises peeling the edge of the glass panel by bringing a hot body into contact with the edge of the glass panel,
at least one point in an effective heating portion of a periphery of the hot body is in contact with the non-chamfered glass panel during the heat-chamfering of the edge of the non-chamfered glass panel, and
the center angle of the effective heating portion ranges from 0° to 30°.

8. A method of fabricating a glass panel, the method comprising:
cutting a glass sheet along a first sideline segment;
cutting the glass sheet along a corner line segment set connected to the first sideline segment; and
cutting the glass sheet along a second sideline segment connected to the corner line segment set, and
wherein an extension of the first sideline segment and an extension of the second sideline segment intersect each other at a first interior angle narrower than 230°, the first sideline segment and the corner line segment set are connected at an interior angle wider than the first interior angle and 180° but narrower than 230°, and the corner line segment set and the second sideline segment are connected at an interior angle wider than the first interior angle and 180° but narrower than 230°.

9. The method of claim 8, wherein the corner line segment set comprises:
a first corner line end segment connected to the first sideline segment;
a second corner line end segment connected to the second sideline segment; and
at least one intermediate corner line segment connecting the first corner line end segment and the second corner line end segment,
wherein the first corner line end segment, the at least one intermediate corner line segment, and the second corner line end segment are connected at interior angles respectively wider than 100° but narrower than 230°.

10. The method of claim 9, wherein the at least one intermediate corner line segment comprises a curvature that is 0 mm⁻¹ or wider.

11. The method of claim 9, wherein each of the first corner line end segment and the second corner line end segment comprises a curvature that is 0 mm⁻¹ or wider.

12. The method of claim 8, wherein the glass sheet is cut along the first sideline segment, the corner line segment set, and the second sideline segment by continuous processing.

13. The method of claim 8, wherein each segment of the first sideline segment, the corner line segment set, and the second sideline segment is a line segment defined by a single functional formula.

14. The method of claim 8, wherein the length of each of the first sideline segment and the second sideline segment is 15 mm or longer.

15. The method of claim 8, further comprising heat-chamfering an edge of the non-chamfered glass panel.

16. The method of claim 15, wherein the heat-chamfering comprises peeling the edge of the non-chamfered glass panel by bringing a hot body into contact with the edge of the non-chamfered glass panel,
at least one point in an effective heating portion of a periphery of the hot body is in contact with the non-chamfered glass panel during the heat-chamfering of the edge of the non-chamfered glass panel, and
the center angle of the effective heating portion ranges from 0° to 30°.

17. A method of fabricating a glass panel, the method comprising:
heat-chamfering an edge of a non-chamfered glass panel,
wherein the heat-chamfering comprises peeling the edge of the non-chamfered glass panel by bringing a hot body into contact with the edge of the non-chamfered glass panel,
at least one point in an effective heating portion of a periphery of the hot body is in contact with the non-chamfered glass panel during the heat-chamfering of the non-chamfered glass panel, and
the center angle of the effective heating portion ranges from 0° to 30°.
